(19) United States
(12) Patent Application Publication
(10) Pub. No.: US 2008/0196199 A1
(43) Pub. Date: Aug. 21, 2008

(54) Tool handle structure

(76) Inventor: Hung-Wel Lin, Taichung (TW)

Correspondence Address: HUNG WEL LIN, P.O. BOX 215, TAICHUNG, 40099, omitted

(21) Appl. No.: 11/715,417

(22) Filed: Mar. 8, 2007

(30) Foreign Application Priority Data
Feb. 16, 2007 (TW) 096203169

(51) Int. Cl. E05B 7/00

(52) U.S. Cl. 16/110.1

(57) ABSTRACT

This invention proposes a tool handle structure with features of easy assembly, ergonomic excellence, durable against powerful forces & shocks, and firm interactions between components. It comprises a grip, a tool bar, a connecting device, and a fixing body. The grip comprises a penetrating hole in shaft axis with a conical opening in one end and a fitting concave in the other end. The tool bar comprises a connecting body with a conical end, which can fit with the penetrating hole, and an outer groove set close to the conical end with the connecting device mounting on it. The fixing body comprises a tubing cap with a connecting hole, which is specially shaped to fit with the fitting concave of the grip externally, and the connecting body of the tool bar internally.

### BACKGROUND OF THE INVENTION

The prior art as U.S. Pat. No. 6,772,994 B1 ┌F PRY BAR HANDLE mainly comprises parts of a grip with a hard body base covered by a soft peel, a shaft-axis hole, a pry bar, a concave at the bottom of the shaft-axis hole, and a hammering cap.

Its main drawbacks are: (1) the connection between the pry bar and grip is weak, making them easily broken when a hammering force is exerted, because a hammering force will generate forces coming from multiple directions and also driving torques. This would put the operator in danger. (2) The fitting of the pry bar and the shaft-axis hole will be either hard to assembly together or too loose because they do not have conical design in their ends. (This problem will be more understandable by reading the descriptions of the embodiment of this invention.) If glue needs to be applied for the case of loosing fitting, the costs of manufacturing would increase due to extra manufacturing process and material, also, the glue may overflow out of the grip, causing the concern of beauty.

### BRIEF SUMMARY OF THE INVENTION

The purpose of this invention is to propose a tool handle structure that solves the problems occurring in prior art and with features of easy assembly, ergonomic excellence, durable against powerful forces & shocks, and firm interactions between components. To reach this end, the proposed tool handle structure comprises a grip, a tool bar, a connecting device, and a fixing body. The grip comprises a penetrating hole in shaft axis with a conical opening in one end and a fitting concave, which is wider in dimension than the penetrating hole, in the other end. The tool bar has, in one side, a connecting body that can firmly fit with the penetrating hole of the grip, and has a conical end in the end employed to easily pass through the conical opening for easy assembly purpose. Moreover, an outer groove is set close to the conical end for positioning the connecting device. The fixing body, made of non-fragile metal material, comprises a tubing cap with a connecting hole, which is specially shaped to firmly fit with the fitting concave of the grip externally, and the connecting body of the tool bar internally. And inside the connecting hole sets an inner groove for collaborating with the outer groove of the tool bar.

### BRIEF DESCRIPTION OF THE DRAWINGS

FIG. 1—an exploded view of first preferred embodiment

FIG. 2—a perspective view of first preferred embodiment

FIG. 3—a sectional view of first preferred embodiment

FIG. 4—a partial close-up view of FIG. 3

FIG. 5—a front view of first preferred embodiment

FIG. 6—a bird view of first preferred embodiment

FIG. 7—an exploded view of second preferred embodiment

FIG. 8—a perspective view of second preferred embodiment

FIG. 9—a front view of second preferred embodiment

FIG. 10—a sectional view of FIG. 9

FIG. 11—a partial close-up view of FIG. 10

FIG. 12—a sectional view of FIG. 9 with 90-degree rotation

### DETAILED DESCRIPTION OF THE INVENTION

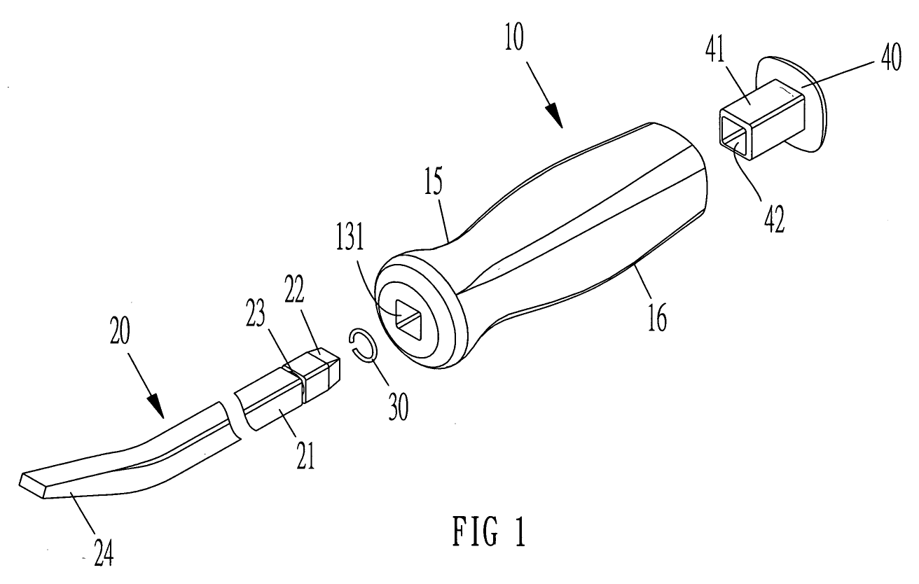

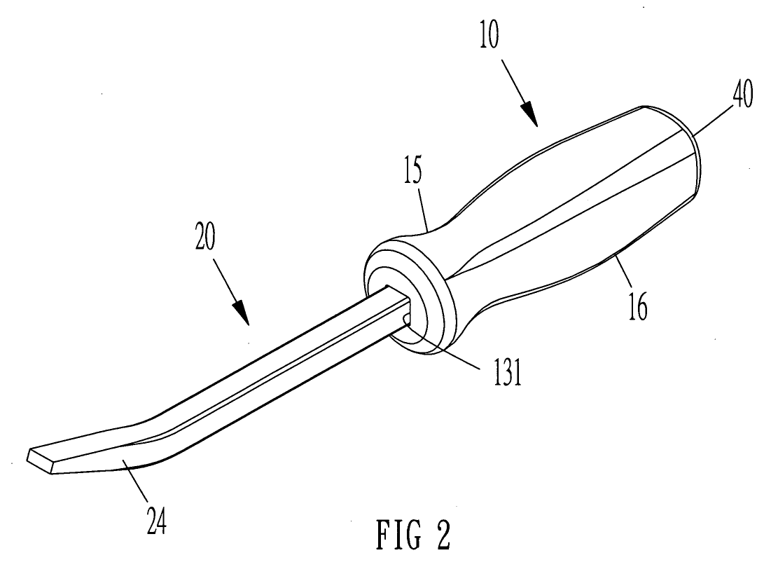

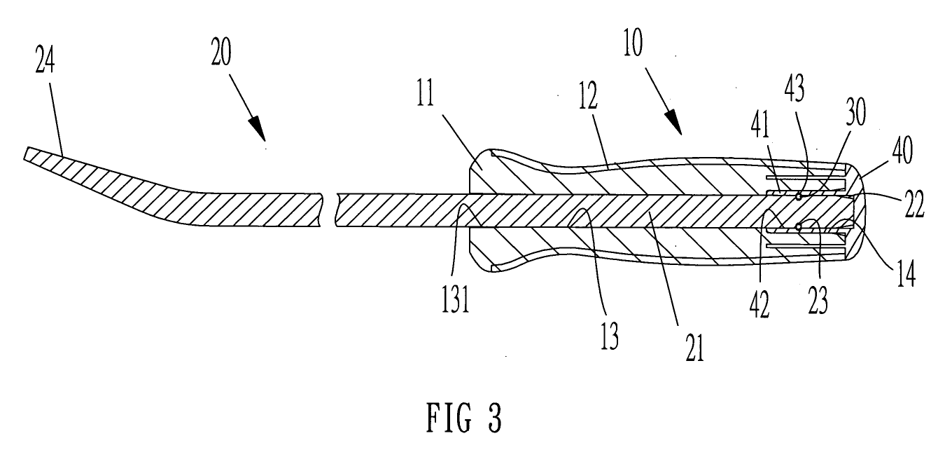

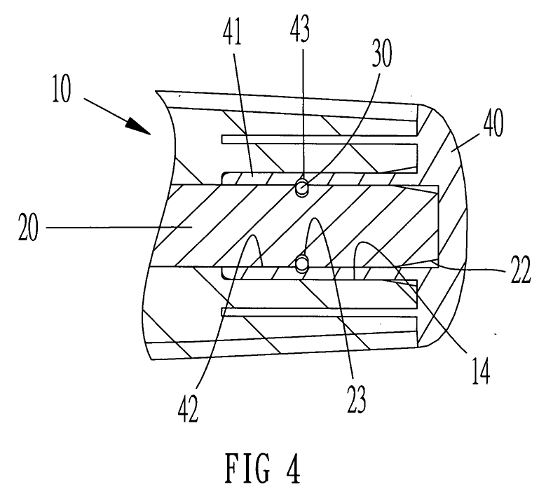

Below please be described of the preferred embodiment with references to the drawings. As shown in FIG. 1-6, the first preferred embodiment of a tool handle structure comprises a grip 10, a tool bar 20, at least a connecting device 30, and a fixing body 40.

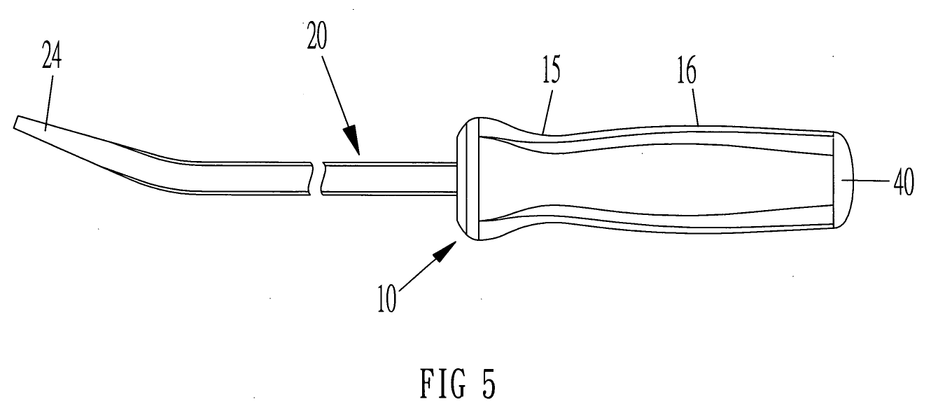

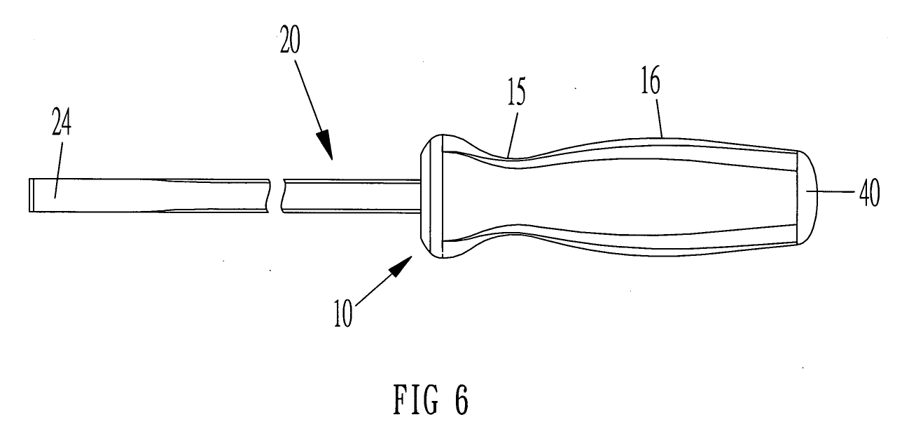

The grip 10 comprises a body base 11 with hard plastics as the material, a soft plastic peel 12 covered externally that can provide touching comforts and absorb vibrations, and a penetrating hole 13 in shaft axis with a conical opening 131 in one end and a fitting concave 14, which is wider in dimension than the penetrating hole 13, in the other end. For the concerns of ergonomics, the shape feature of the grip 10 is that it has concaved curve 15 in front, convex curve 16 in middle and cuboid-shaped in the back for well fitting with the part between the thumb and the index finger when being held by hands, so that the users can comfortably exert forces. (As shown in FIGS. 5 and 6)

The tool bar 20 has, in one side, a connecting body 21 that firmly fits with the penetrating hole 13, and has a conical end 22 in the end employed to easily pass through the conical opening 131 for easy assembly purpose. Moreover, an outer groove 23 is set close to the conical end 22 for positioning the connecting device 30. In the other side of the tool bar 20 is a properly elongated bar that extends out of the grip and has a working end 24 in its end.

The connecting device 30, installed between the outer groove 23 and the inner groove 43 for mounting the tool bar 20 and the fixing body 40 together, can be a c-clamp, balls and etc.

The fixing body 40, made of non-fragile metal material, has a tubing cap 41 that has a connecting hole 42, and is specially shaped to firmly fit with the fitting concave 14 of the grip 10 externally, and the connecting body 21 of the tool bar 20 internally. Inside the connecting hole 42 sets an inner groove 43 for collaborating with the outer groove 23 of the tool bar 20.

When assembling, the tool bar 20 is first inserted through the penetrating hole 13 with connecting device 30 installed on it, and the fixing body 40 is then hit into the fitting concave 14 until the connecting device 30 is well fixed between the outer groove 23 of the tool bar 20 and the inner groove 43 inside the connecting hole 42 of the fixing body 40. Thus, the proposed tool handle structure can keep all components firmly positioned and be durable against all kinds of impacts of forces.

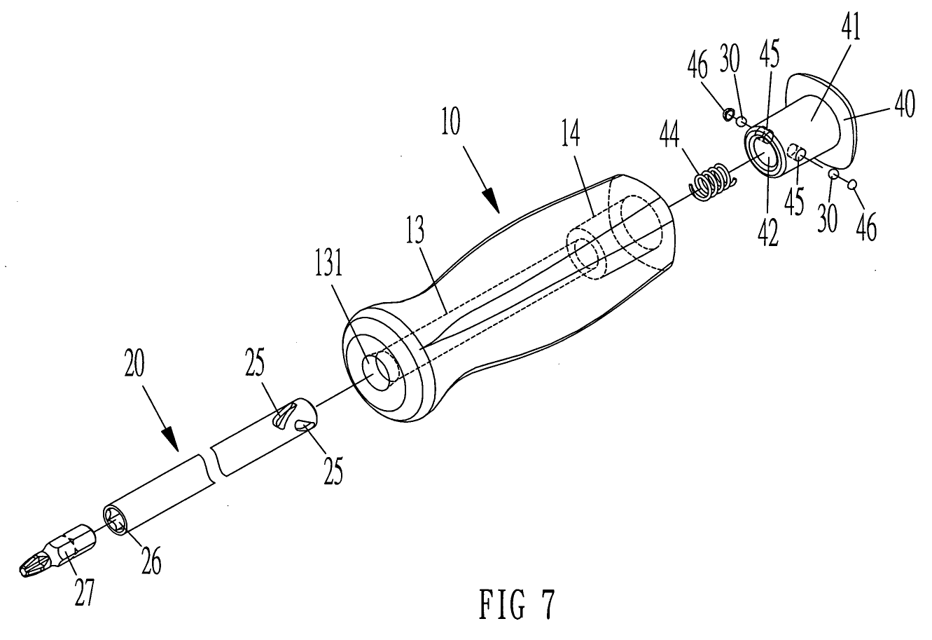

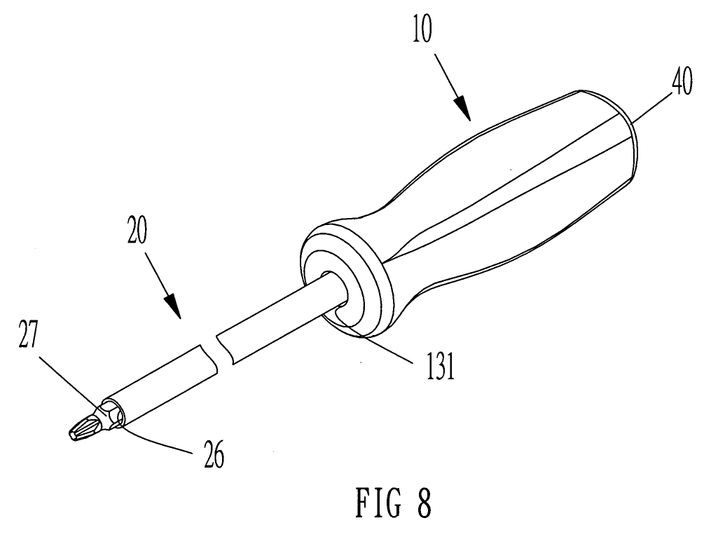

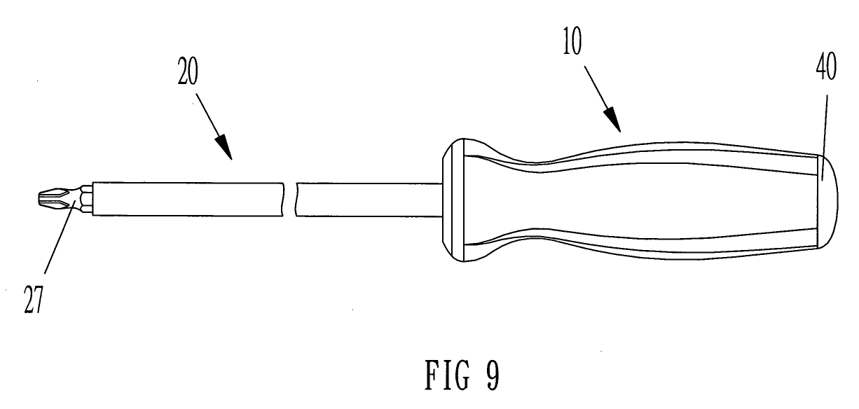

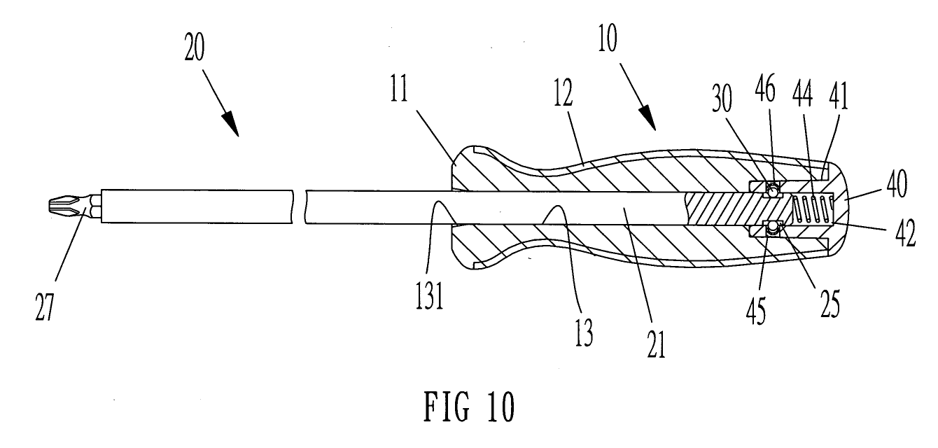

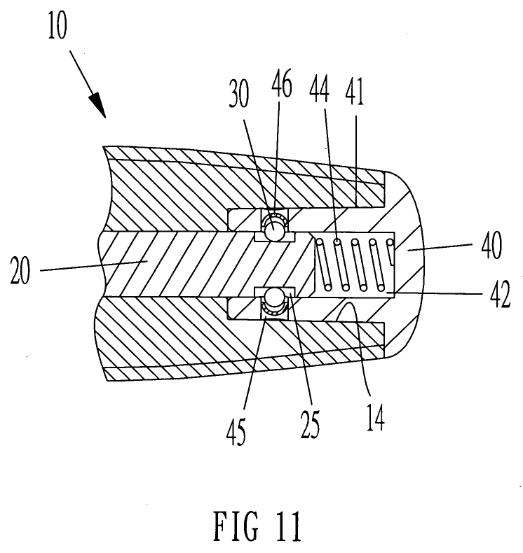

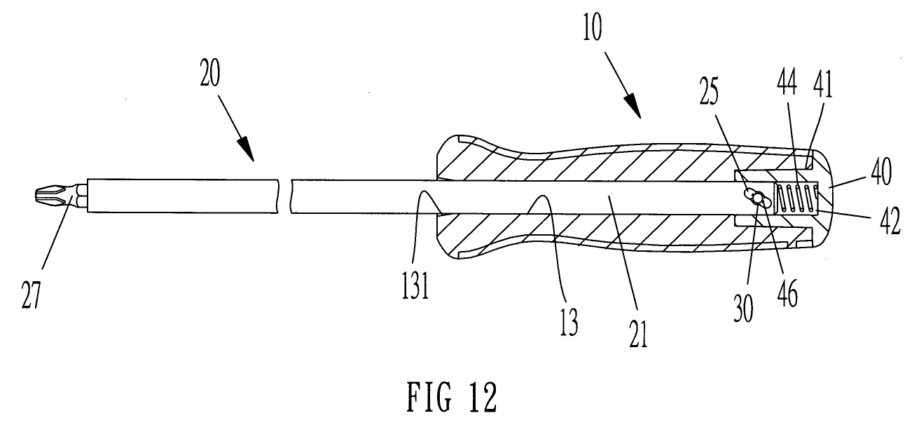

Further, as shown in FIG. 7-12, the second preferred embodiment of a tool handle structure employs different device for the connecting device 30 and special mechanism, which can generate driving torque by hammering, and is thus very helpful in certain conditions, such as loosing an overly tightened screw.

Its features comprises: a grip 10 similar to that of the first preferred embodiment, a tool bar 20, similar to that of the first preferred embodiment, further has symmetrical slant rectangular grooves 25 close to the conical end 22 and a polygon hole 26 in the front end for loading various types of driver bits 27 (in the drawings, a Phillip-type driver bit is taken as example), and a fixing body 40 that has a tubing cap 41 with symmetrical containing holes 45 set on the wall and a connecting hole 42 with a spring device 44 mounted inside (it could be a regular spring.) Besides, the containing holes 45 further contain connecting devices 30 inside, which are positioning balls in this example.

With aforementioned components, the tool bar 20 is first inserted through the penetrating hole 13, and the tubing cap 41 of the fixing body 40 then firmly fit with the fitting concave 14 of the grip 10 externally, and the connecting body 21 of the tool bar 20 internally, with the connecting device 30 fitting into the slant rectangular grooves 25 of the tool bar 20. The spring device 44 thus depressingly stays against the inner wall of the tubing cap 41 and conical end 22 on its both ends.

Given above tool structure, when hammering on the fixing body 40, the hammering power would turn into driving torque on the tool bar 20 because the positioning balls 30 have to move forwards along the slant rectangular grooves 25 of the tool bar 20. Coupling with the hammering vibrations, even an overly tightened screw can be thus easily loosed. The depressed spring device 44 then can push the fixing body 40 and positioning balls 30 back to its original standby position when no hammering force is exerted.

Furthermore, in order for easy assembly, a hemispherical cap 46 is employed to cap the containing holes 45 to prevent the positioning balls 30 from easily sliding out of containing holes 45.

With all aforementioned, the invention deserves grant of a patent based on its capability of industrial application and absolute novelty. The example illustrated above is just an exemplary embodiment for the invention, and shall not be utilized to confine the scope of the patent. Any equivalent modifications within the scope of claims of the patent shall be covered in the protection for this patent.

What is claimed is:

1. A tool handle structure comprising a grip, a tool bar, a connecting device, and a fixing body;
The said grip comprises a penetrating hole in shaft axis with a conical opening in one end and a fitting concave, which is wider in dimension than the said penetrating hole, in the other end;
The said tool bar comprises a connecting body with a conical end, which can fit with the said penetrating hole, and an outer groove set close to the said conical end for positioning the said connecting device;
The said connecting device is installed between the said outer groove of the said tool bar and the inner groove of the said fixing body for mounting the said tool bar and fixing body together;
The said fixing body comprises a tubing cap with a connecting hole, which is specially shaped to fit with the said fitting concave of the said grip externally, and the said connecting body of the said tool bar internally; inside the said connecting hole sets an inner groove for collaborating with the said outer groove of the said tool bar.

2. The tool handle structure of claim 1, wherein the said grip further comprises a body base with hard plastics as the material, and a soft plastic peel covered externally.

3. The tool handle structure of claim 1, wherein the said connecting device is a c-clamp.

4. The tool handle structure of claim 1, wherein the said fixing tube is made of non-fragile metal material.

5. A tool handle structure comprising a grip, a tool bar, a connecting device, and a fixing body;
The said grip comprises a penetrating hole in shaft axis with a conical opening in one end and a fitting concave, which is wider in dimension than the said penetrating hole, in the other end;
The said tool bar comprises, in one side, a connecting body with a conical end, which can fit with the said penetrating hole, and symmetrical slant rectangular grooves set close to the said conical end, and comprises a polygon hole in the other side for loading various driver bits;
The said connecting device is installed between the said slant rectangular grooves of the said tool bar and the containing holes of the said fixing body for connecting the said tool bar and fixing body together;
The said fixing body comprises a tubing cap with symmetrical containing holes set on its wall and a connecting hole with a spring device mounted inside; the said containing holes can contain the said connecting devices inside, making the said connecting devices stay between the said fixing body and the said slant rectangular grooves when assembling.

6. The tool handle structure of claim 5, wherein the said connecting devices are balls.

7. The tool handle structure of claim 5, wherein the said spring device is a regular depressing spring.

8. The tool handle structure of claim 5, wherein the said connecting devices are capped by hemispherical caps externally when assembling.

9. The tool handle structure of claim 5, wherein the said grip is concave-curved in front, convex-curved in middle and cuboid-shaped in the back.
